(19) United States
(12) Patent Application Publication
(10) Pub. No.: US 2004/0251653 A1
(43) Pub. Date: Dec. 16, 2004

(54) Air suspension

(75) Inventor: Fujio Momiyama, Yachiyo-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: HORIKIRI, INC., Yachiyo-shi (JP)

(21) Appl. No.: 10/829,268

(22) Filed: Apr. 22, 2004

(30) Foreign Application Priority Data
Jun. 10, 2003 (JP) 2003-164739

(51) Int. Cl. B60G 11/27; B60B 35/08

(52) U.S. Cl. 280/124.157; 301/124.1

(57) ABSTRACT

An air suspension has a hollow axle beam 1 suspended from opposite side rails 3 via air springs 5. In order to supplement volumes of the respective air springs 5 without addition of new tank equipment, an inner space of the axle beam 1 is divided by an intermediate partition 12 into two divided spaces which are respectively communicated as surge tanks 13 with the air springs 5 for supplement of the volumes of the air springs 5.

### CROSS-REFERENCE TO RELATED APPLICATION

This application is related to and claims priority, under 35 U.S.C. §119, from Japanese Patent Application No. 2003-164739, filed in the Japanese Patent Office on Jun. 10, 2003, the entire contents of which is hereby incorporated by reference herein.

### BACKGROUND OF THE INVENTION

1. Field of the Invention

The present invention relates to an air suspension.

2. Discussion of Background

FIGS. 1 and 2 show a conventional front suspension for a large-sized vehicle such as a truck or a bus. Reference numeral 1 denotes a front axle beam extending laterally of opposite side rails 3 and of the vehicle. The axle beam 1 bears wheels 2 at its opposite ends.

The axle beam 1 has brackets 4 mounted on it to provide seats for receiving air springs 5 which support the side rails 3.

Each of the side rails 3 has a downwardly extending support member 6 mounted on it at a position forwardly of the air spring 5. A lower end of the support member 6 and a front surface of the bracket 4 are interconnected by a lower rod 7 via pivotal connections; in other words, the lower rod 7 is connected at its rear and front ends to the bracket 4 and support member 6, respectively, through the pivotal connections.

Also connected to the bracket 4 is a lower end of a shock absorber 8 whose upper end is connected to the side rail 3 arranged just thereabove. The shock absorber 8 serves to suppress vertically repeated vibrations and attenuate the vibrations.

Mounted on a central portion of the axle beam 1 is an upwardly extending support member 9 a top end of which is connected via an upper rod 11 to a central portion of a cross member 10 extending between the opposite support members 6. A lateral rod for regulating lateral motions of the chassis is omitted from the drawings.

The above-mentioned air suspension which provides a front suspension structure requires air springs 5 with greater air volumes to lower the spring constant for improvement of riding comfort. When such larger air springs 5 have difficulty in arrangement of them in a narrower space between the side rails 3 and the axle beam 1, surge tanks (not shown) are independently arranged for supplement of the lacked volumes for the respective air springs 5 and are communicated with the air springs 5 so as to increase working air volumes and lower the spring constant of the air springs 5.

A front suspension structure using such air springs is disclosed, for example, in JP 2001-287527A.

However, addition of and equipping with new tank equipment as surge tanks may bring about substantial rise in cost, inevitably increase the overall weight of the vehicle and have difficulty in securement of a space for arranging the tank equipment.

### BRIEF SUMMARY OF THE INVENTION

The present invention was made in view of the above and has its object to provide an air suspension which can supplement volumes of air springs without addition of new tank equipment.

The invention is directed to an air suspension comprising a hollow axle beam suspended via air springs from opposite side rails, an inner space of the axle beam being divided by an intermediate partition into two divided spaces which are respectively communicated as serge tanks with the air springs for supplement of volumes of the air springs.

Thus, the inner space of the axle beam which has not been utilized at all can be used as surge tanks to supplement the volumes of the air springs so as to lower the spring constant to any desired value without addition of new tank equipment.

The inner space of the axle beam is not communicated with the air springs as it is, but is divided by a partition into two divided spaces which are respectively communicated with the air springs. As a result, the volumes of the respective air springs can be properly supplemented so that lowering of rolling rigidity due to excessively lowered spring constant is prevented to keep the drivability well.

### BRIEF DESCRIPTION OF THE DRAWINGS

FIG. 1 is a side view of a conventional air suspension;

FIG. 2 is a perspective view of the air suspension shown in FIG. 1;

FIG. 3 is a side view of an embodiment according to the invention; and

FIG. 4 is a perspective view of the embodiment shown in FIG. 3 with the axle beam being partially cut out.

### DETAILED DESCRIPTION OF THE PREFERRED EMBODIMENT

An embodiment of the invention will be described in conjunction with the attached drawings.

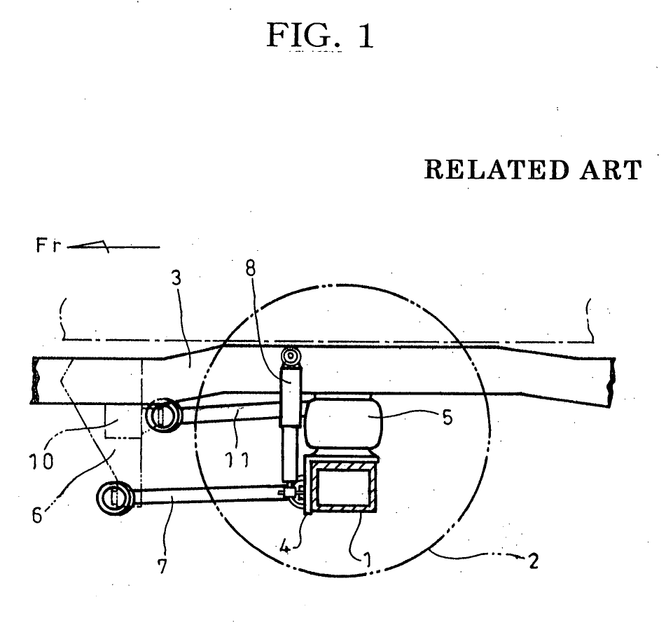

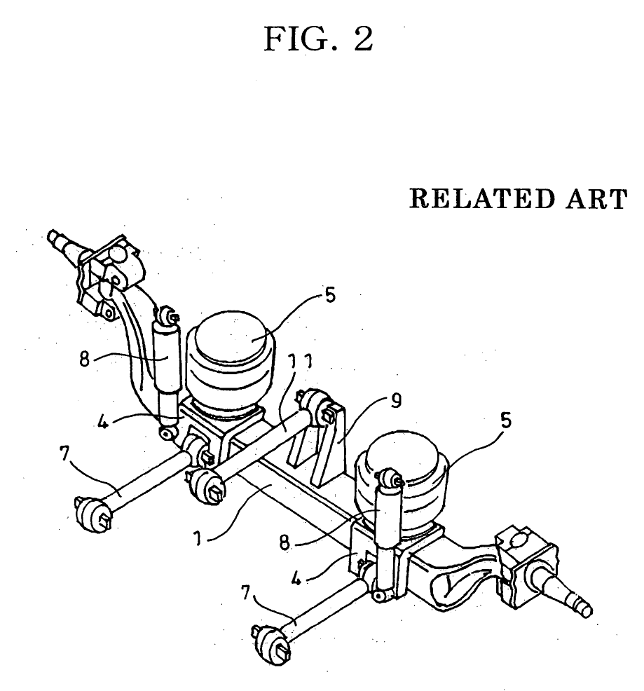

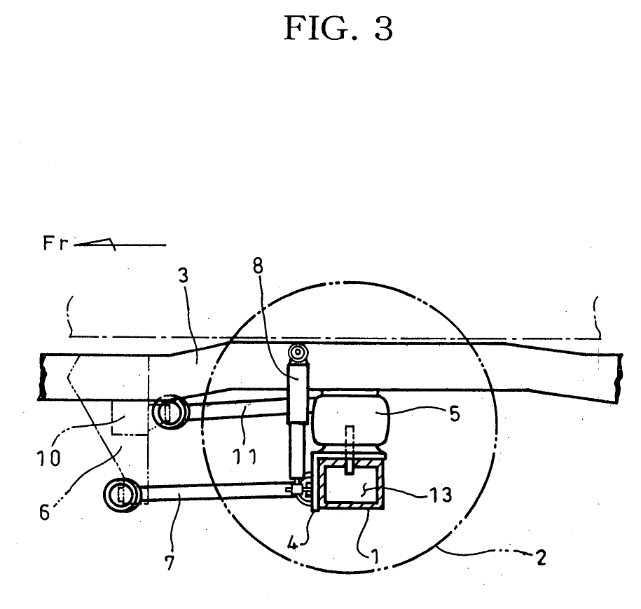

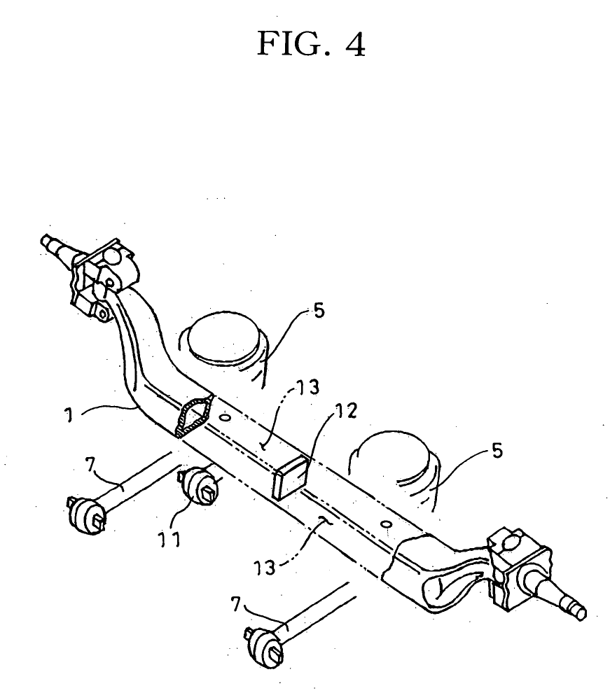

According to the embodiment, a front air suspension is constructed substantially similar to that shown in FIGS. 1 and 2 except that, as shown in FIGS. 3 and 4, an inner space of a hollow axle beam 1 is divided by an intermediate partition 12 into two divided spaces which are respectively communicated as surge tanks 13 with the air springs 5 to supplement the volumes of the air springs 5.

In the embodiment shown, a through hole is formed through an upper portion of the axle beam 1, a horizontal portion of the bracket 4 and a bottom portion of the air spring 5 for direct communication of the surge tank 13 with the air spring 5; however, an orifice or a throttle valve may be interposed between them.

For utilization of the inner space of the axle beam 1 as the surge tanks 13, of course, an interior of the axle beam 1 may be processed for securement of airtightness and/or a further partition or partitions may be added so as to regulate the volumes of the surge tanks 13 into optimum values.

In the air suspension thus constructed, the inner space of the axle beam 1 which has not been utilized at all can be used as surge tanks 13 to supplement the volumes of the respective air springs 5 and lower the spring constant to any desired value without addition of and equipping with new tank equipment.

The inner space of the axle beam 1 is not communicated with the respective air springs 5 as it is, but is divided by the partition 12 into two divided spaces which are respectively communicated with the respective air springs 5. As a result, the volumes of the respective air springs 5 can be properly supplemented so that lowering of rolling rigidity due to excessively lowered spring constant is prevented to keep the drivability well.

That is, if the inner space of the axle beam 1 were communicated with the air springs 5 as it is, the volumes of the air springs 5 would be increased more than needed, leading to extremely lowered spring effect; as a result, rolling and the like of the chassis might tend to be caused and the drivability might be deteriorated. Therefore, division of the inner space is effected by way of preventing such inconveniences from occurring.

Thus, according to the above embodiment, with no addition of new tank equipment, the inner space of the axle beam 1 is used as the surge tanks 13 for supplement of the volumes of the respective air springs 5. As a result, with no extreme increase of cost, with no increase in the overall weight of the vehicle and with no problem on securement of space for arrangement, the spring constant of the air springs 5 can be lowered to improve riding comfort. Moreover, lowering of the rolling rigidity due to extremely lowered spring constant can be prevented from occurring and the drivability can be kept well.

It is to be understood that the present invention is not limited to the embodiment described above and that various changes and modifications may be made without departing from the spirit of the invention. For example, though the axle beam has been described and illustrated to have a rectangular section, the invention may be applicable also to an axle beam with a cylindrical section.

What is claimed as new and desired to be secured by Letters Patent of the United States is:

1. An air suspension comprising a hollow axle beam suspended via air springs from opposite side rails, an inner space of the axle beam being divided by an intermediate partition into two divided spaces which are respectively communicated as surge tanks with the air springs for supplement of volumes of the air springs.
